(19) United States
(12) Patent Application Publication
(10) Pub. No.: US 2025/0291562 A1
(43) Pub. Date: Sep. 18, 2025

(54) WORK SUPPORT SYSTEM, WORK SUPPORT METHOD, AND INFORMATION STORAGE MEDIUM

(71) Applicant: Cybozu, Inc., Tokyo (JP)

(72) Inventors: Yoshiaki YAJIMA, Shiki-shi (JP); Tatsuya SASAKI, Shinshiro-shi (JP); Wataru IIJIMA, Kitamoto-shi (JP); Yuki NAKAJIMA, Tokyo (JP)

(21) Appl. No.: 19/079,494

(22) Filed: Mar. 14, 2025

(30) Foreign Application Priority Data
Mar. 18, 2024 (JP) 2024-042330

(51) Int. Cl. G06F 8/35

(52) U.S. Cl. CPC G06F 8/35

(57) ABSTRACT

Provided is a work support system, which is configured to support work of a user with no-code or low-code, the work support system including at least one processor configured to: acquire, based on input of the user, extension content information relating to extension content of a work support function in the work support system; generate, based on the extension content information and an AI, code for extension of the work support function; and provide the code to the user.

### CROSS-REFERENCE TO RELATED APPLICATION

The present disclosure contains subject matter related to that disclosed in Japanese Patent Application JP 2024-042330 filed in the Japan Patent Office on Mar. 18, 2024, the entire contents of which are hereby incorporated by reference.

### BACKGROUND OF THE INVENTION

### 1. Field of the Invention

The present disclosure relates to a work support system, a work support method, and an information storage medium.

### 2. Description of the Related Art

Hitherto, there are known technologies capable of supporting work of users with no-code or low-code. For example, in Japanese Patent Application Laid-open No. 2023-018851, there is described an automatic code generation system that acquires text data from a document or a conversational sentence, extracts a context by performing natural language analysis of the acquired text data, and generates one or more programs corresponding to the extracted context by referring to a code database in which one or more codes are stored in association with each context, a program grammar analysis database in which a grammar book of a programming language is recorded, and an automatic program generation knowledge database in which a program streamlined for each processing operation to be implemented is associated with the processing operation.

For example, in Japanese Patent No. 7378003, there is described a website creation support device that derives source code of a subject website to be created through use of a large language model with text data, in which content of the subject website is described in a natural language by a user, being used as input to the large language model, presents, to the user, a preview of the subject website when displayed on a web browser through use of the source code, determines a URL of the subject website in response to an operation of the user for designating the URL, and uploads the source code to a server of a hosting service, which is associated with the URL, and for which the user has an account, to thereby publish the subject website on the Internet.

However, the technology of Japanese Patent Application Laid-open No. 2023-018851 enables code to be automatically generated through use of databases including the code database, but does not involve generating code for functional extension in a work support system capable of supporting work of users with no-code or low-code. In the same manner, the technology of Japanese Patent No. 7378003 enables code to be automatically generated through use of the large language model, but does not involve generating code for functional extension in the work support system. For that reason, the related-art technology has not been able to increase convenience of a user who uses the work support system.

### SUMMARY OF THE INVENTION

One object of the present disclosure is to increase convenience of a user.

According to at least one aspect of the present disclosure, there is provided a work support system, which is configured to support work of a user with no-code or low-code, the work support system including at least one processor configured to: acquire, based on input of the user, extension content information relating to extension content of a work support function in the work support system; generate, based on the extension content information and an AI, code for extension of the work support function; and provide the code to the user.

### BRIEF DESCRIPTION OF THE DRAWINGS

FIG. 1 is a diagram for illustrating an example of a hardware configuration of a work support system.

FIG. 2 is a view for illustrating an example of a work support screen displayed on a user terminal.

FIG. 3 is a view for illustrating an example of the work support screen displayed on the user terminal.

FIG. 4 is a diagram for illustrating an example of functions implemented in the work support system.

FIG. 5 is a table for showing an example of a template database.

FIG. 6 is a diagram for illustrating an example of an AT used in generation of code.

FIG. 7 is a table for showing an example of a work support database.

FIG. 8 is a flow chart for illustrating an example of processing executed in the work support system.

FIG. 9 is a diagram for illustrating an example of functions implemented in a work support system according to modification examples.

FIG. 10 is a diagram for illustrating an example of processing for correction of the code.

FIG. 11 is a view for illustrating an example of a work support screen in Modification Example 3.

### DESCRIPTION OF THE EMBODIMENTS

### 1. Hardware Configuration

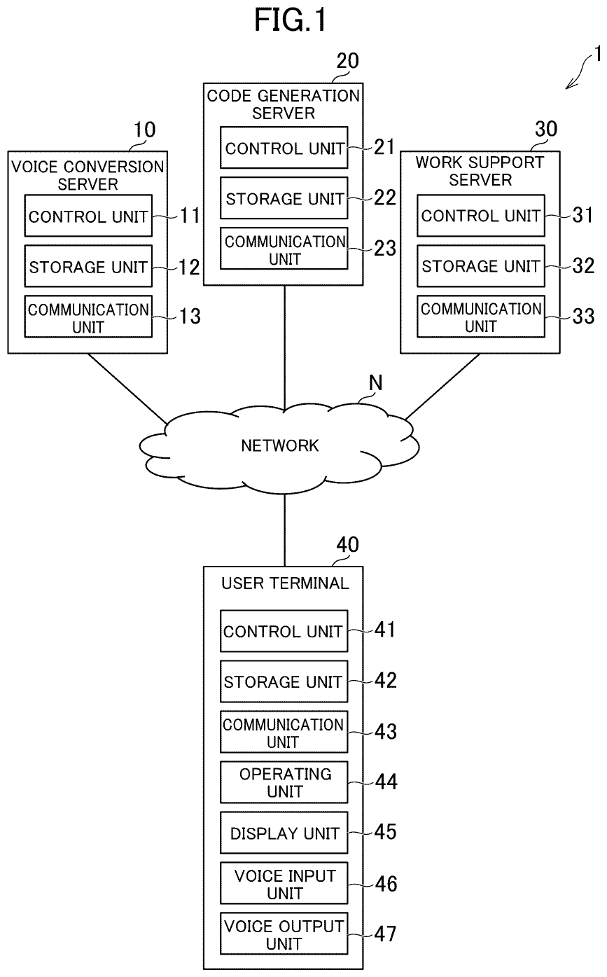

An example of a work support system, a work support method, and a program according to at least one embodiment of the present disclosure is described. FIG. 1 is a diagram for illustrating an example of a hardware configuration of the work support system. For example, a work support system 1 includes a voice conversion server 10, a code generation server 20, a work support server 30, and a user terminal 40. Each of the voice conversion server 10, the code generation server 20, the work support server 30, and the user terminal 40 is connected to a network N such as the Internet or a LAN. One voice conversion server 10, one code generation server 20, one work support server 30, and one user terminal 40 are illustrated in FIG. 1, but at least one thereof may be provided as two or more components.

The voice conversion server 10 is a server computer that executes voice conversion processing described below. For example, the voice conversion server 10 includes a control unit 11, a storage unit 12, and a communication unit 13. The control unit 11 includes at least one processor. The storage unit 12 includes at least one of a volatile memory such as a RAM, or a non-volatile memory such as a flash memory. The communication unit 13 includes at least one of a communication interface for wired communication or a communication interface for wireless communication.

The code generation server 20 is a server computer that executes code generation processing described below. For example, the code generation server 20 includes a control unit 21, a storage unit 22, and a communication unit 23. Hardware configurations of the control unit 21, the storage unit 22, and the communication unit 23 may be the same as those of the control unit 11, the storage unit 12, and the communication unit 13, respectively.

The work support server 30 is a server computer that executes work support processing described below. For example, the work support server 30 includes a control unit 31, a storage unit 32, and a communication unit 33. Hardware configurations of the control unit 31, the storage unit 32, and the communication unit 33 may be the same as those of the control unit 11, the storage unit 12, and the communication unit 13, respectively.

The user terminal 40 is a computer of a user. For example, the user terminal 40 is a personal computer, a tablet terminal, a smartphone, or a wearable terminal. The user terminal 40 includes a control unit 41, a storage unit 42, a communication unit 43, an operating unit 44, a display unit 45, a voice input unit 46, and a voice output unit 47. Hardware configurations of the control unit 41, the storage unit 42, and the communication unit 43 may be the same as those of the control unit 11, the storage unit 12, and the communication unit 13, respectively. The operating unit 44 includes an input device such as a mouse or a touch panel. The display unit 45 includes a liquid crystal display or an organic EL display. The voice input unit 46 includes at least one microphone. The voice output unit 47 includes at least one speaker.

Programs stored in the storage units 12, 22, 32, and 42 may be supplied via the network N. A hardware configuration of each of the voice conversion server 10, the code generation server 20, the work support server 30, and the user terminal 40 is not limited to the example of FIG. 1. For example, at least one of the voice conversion server 10, the code generation server 20, the work support server 30, or the user terminal 40 may include at least one of a reading unit (for example, a memory card slot) that reads a computer-readable information storage medium or an input/output unit (for example, a USB terminal) for directly connecting to an external device. A program stored in the information storage medium may be supplied to at least one of the voice conversion server 10, the code generation server 20, the work support server 30, or the user terminal 40 through at least one of the reading unit or the input/output unit.

Moreover, the work support system 1 is only required to include at least one computer. The computers included in the work support system 1 are not limited to the example of FIG. 1. For example, the work support system 1 may include only the code generation server 20 and the work support server 30. In this case, the voice conversion server 10 and the user terminal 40 are present outside the work support system 1. The work support system 1 may include only the code generation server 20. In this case, the voice conversion server 10, the work support server 30, and the user terminal 40 are present outside the work support system 1. The work support system 1 may include the code generation server 20 and another server computer.

### 2. Overview of Work Support System

In the at least one embodiment, the work support system 1 can support work of users with no-code or low-code. The no-code means that the user does not input any code. In other words, the no-code means that the user is not required to input any code to use the work support system 1. The low-code means that the user inputs only minimum required code. In other words, the user is only required to input the minimum required code to use the work support system 1.

The code refers to a command for a computer. In other words, the code refers to information for a computer to understand an instruction of the user. The code may be any code used in the field of computer software. For example, the code may be a programming language code, a cascading style sheets (CSS) code, a database language code, a markup language code, or another code. Programming languages also include languages called scripting languages. The code in the at least one embodiment may be any one of various codes that a person skilled in the field of computer software calls code.

The work support system 1 being able to support work of users with no-code means that the work support system 1 can execute work support processing described below based on code provided in advance even when the user does not input any code. The work support system 1 being able to support work of users with low-code means that, as long as the user inputs only the minimum required code, the work support system 1 can execute the work support processing described below based on the minimum required code input by the user and the code provided in advance.

The meaning of each of the terms “no-code” and “low-code” may be a commonly known meaning. A person skilled in the field of computer software can understand the meaning of each of the no-code and the low-code based on the common general technical knowledge at the time of filing. Each of the no-code and the low-code may have a publicly-known meaning that a person skilled in the art can understand based on the common general technical knowledge at the time of filing. For example, an amount of the minimum required code for the low-code may be an amount that a person skilled in the art can understand based on the common general technical knowledge at the time of filing. For example, the amount of the minimum required code for the low-code may be about 1 line to 100 lines, or may be 101 lines or more.

For example, the work support system 1 has various work support functions for supporting work of users. The work support function is a function implemented by a program developed for work support. Types of work support functions may be publicly-known types. For example, the work support function may be a database function for the user to store data in a database, a communication function for the user to communicate with another user, a schedule function for the user to manage a schedule, an email management function for the user to manage emails, or another function.

In the at least one embodiment, a case in which the work support system 1 provides users with groupware of a cloud type is taken as an example. The work support system 1 may provide users with groupware of an on-premises type. The work support system 1 may provide users with a service that is not classified as groupware but supports work. For example, an organization such as a corporation to which users belong contracts with the work support system 1. As a member of the organization, each user uses the work support function of the work support system 1. When the user logs in to the work support system 1 from a browser of the user terminal 40, the user terminal 40 displays, on the display unit 45, a work support screen for the user to use the work support function. The work support screen may be displayed on a program dedicated to the work support system 1 instead of being displayed on a browser.

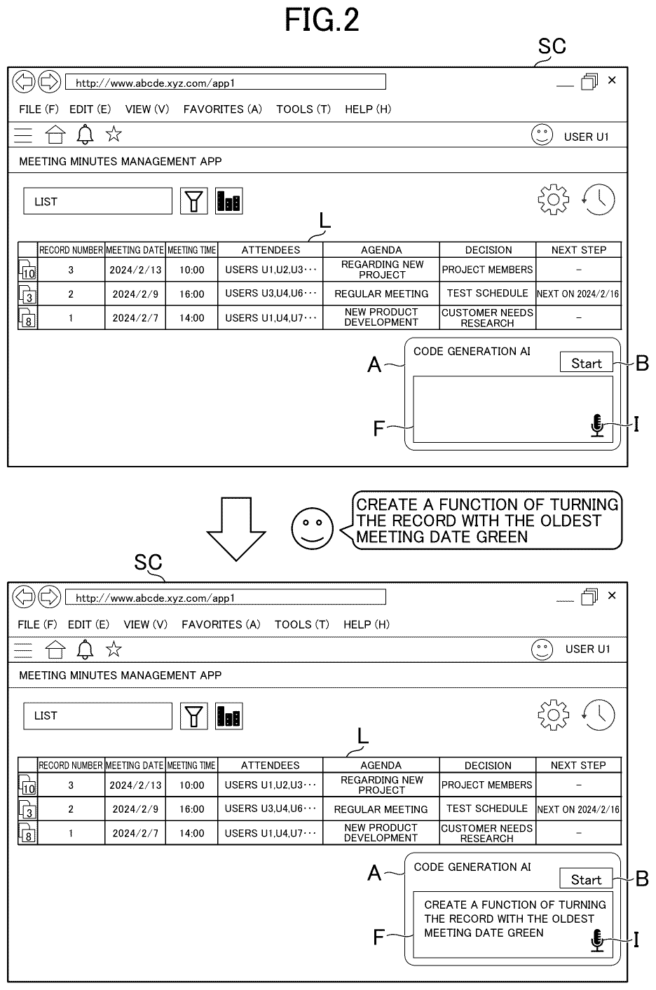

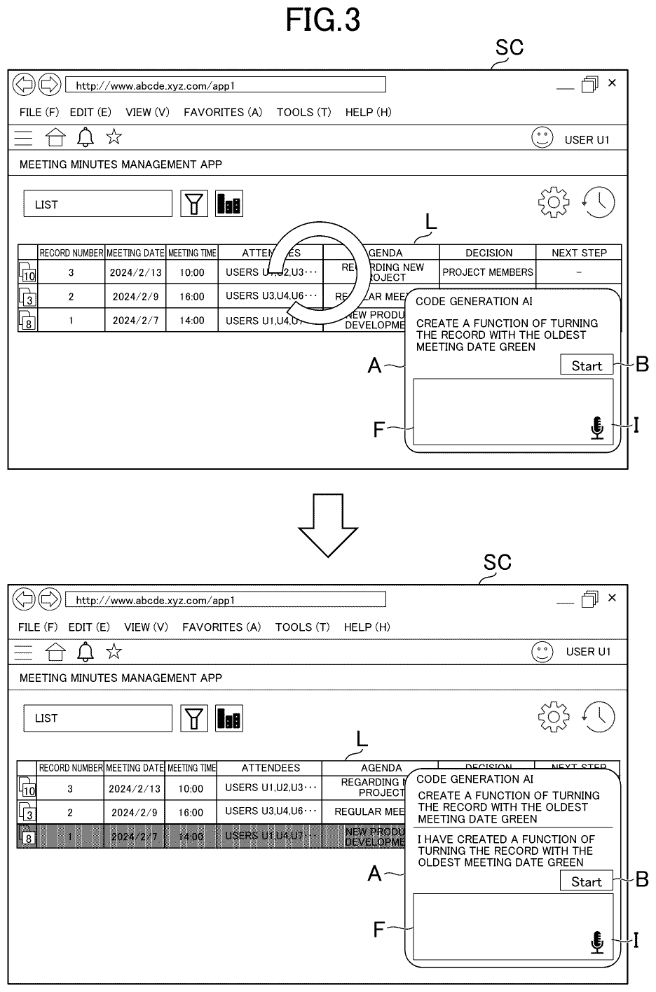

FIG. 2 and FIG. 3 are diagrams for illustrating examples of the work support screen displayed on the user terminal 40. In the at least one embodiment, a case in which the user uses a database function is taken as an example. For example, the user uses an app that is a type of database. The user can store, in the app, any data relating to his or her own work. For example, the user can store, in the app, not only data stored in fields of the app but also other data. For example, the user can store, in the app, comments on other users, files such as documents or images, or other data. The app can be said to be a complex work support function that combines not only the database function but also a communication function and a file management function.

For example, when the user selects the app, the user terminal 40 displays, on the display unit 45, a work support screen SC indicating a list L of records that are units of data that forms the app as in the upper half of FIG. 2. In the example in the upper half of FIG. 2, records of a meeting minutes management app for the user to manage meeting minutes are shown in the list L. When the user selects a record in the list L, the user terminal 40 displays details of the record on the work support screen SC. For example, the user can update the record from the work support screen SC.

In the at least one embodiment, the user can create an app with no-code or low-code. For example, the user can create an app by performing only a simple setting task such as a field setting even without inputting any code. The user can use a default app provided in advance even without performing a setting task. The user can extend the work support function of the app by inputting the minimum required code. That is, the user can create a low-code app by extending the work support function of the app created with no-code. The extension of the work support function can also be said to be customization of the work support function.

For example, the user may extend the function of the app by inputting a script to be executed by the browser of the user terminal 40. The script is a code written in a scripting language. The user may extend the function of the app by inputting a cascading style sheets (CSS) code. The work support system 1 may be compatible with another code other than the script and the CSS. When the user intends to extend the function of the app by inputting those codes, the user is required to have a certain degree of knowledge of codes. Even when the user has knowledge of codes, time and labor are required to input code.

In view of this, the work support system 1 according to the at least one embodiment has a code generation function in which an artificial intelligence (AI) generates code so that the user can easily extend the function of the app. The code generation function may be a default function (function that can be used by all users from the beginning) of the work support system 1, but in the at least one embodiment, is assumed to be a plug-in that can be freely added by the user. The user who wishes to use the code generation function adds the code generation function by the plug-in. The plug-in is a collection of programs and data for the code generation function. When the user adds the plug-in, the user can use the programs and data for the code generation function.

The AI is a program having artificial intelligence that supports work of users. There are various views in terms of definitions of the AI, but the AI in the at least one embodiment may be an AI defined by any one of various publicly-known definitions. The AI may be an AI called a generative AI or a conversational AI. Examples of the AI may include a large language model, a machine learning model not classified as a large language model, a program called a bot, or other programs. There are also various views in terms of definitions of machine learning, but the machine learning in the at least one embodiment may be machine learning defined by any one of various publicly-known definitions. The machine learning may be any one of supervised learning, semi-supervised learning, or unsupervised learning.

In the at least one embodiment, a case in which the large language model corresponds to the AI is taken as an example. In addition, as an example of the code generated by the AI, a script (for example, JavaScript (trademark)) to be executed by the browser of the user terminal 40 is described. For example, the user uses text (characters) or voice to give an instruction to the AI. In the example in the upper half of FIG. 2, the user selects an icon I for starting voice input, and speaks content of the function with which to extend the app. When the voice input unit 46 detects the voice of the user, the user terminal 40 executes, between the user terminal 40 and the voice conversion server 10, processing for converting the voice of the user into text. When the voice of the user is converted into text, as in the lower half of FIG. 2, the user terminal 40 displays the text in an input form F. When the text is incorrect, the user can correct the text by operating the operating unit 44. The user can also manually input text in the input form F without using the voice input.

In the example in the lower half of FIG. 2, the user gives an instruction such as “Create a function of turning the record with the oldest meeting date green.” For example, in order to extend the function of the app so as to satisfy the instruction of the user, the work support system 1 is required to generate code indicating processing for identifying the record with the oldest meeting date and processing for changing a color of the record. The work support system 1 causes the AI to generate the code. For example, when the user selects a button B, the code generation server 20 causes the AI to generate code that meets the instruction of the user. As in the upper half of FIG. 3, support screen SC is in a state waiting for the generation of code. The instruction input by the user is displayed in a display region A of the work support screen SC.

For example, when the code generation server 20 causes the AI to generate code, the work support server 30 deploys the code generated by the AI. When the code generated by the AI is a script to be executed by the browser of the user terminal 40, the user terminal 40 receives the code from the work support server 30, and executes the code by the browser. After the AI generates code that meets the wish of the user, the user terminal 40 can execute the code to turn the record with the oldest meeting date among the records displayed in the list L green as in the lower half of FIG. 3. An answer from the AI is displayed in the display region A of the work support screen SC. When the user performs an operation for ending the generation of code, the code generated by the AI is reflected in the app. When the user does not perform the operation, the code generated by the AI is discarded.

As described above, when the user inputs an instruction to the AI in order to extend the work support function of the app, the work support system 1 causes the AI to generate code for the extension of the work support function. The work support system 1 implements the extension of a function that meets the wish of the user based on the code generated by the AI. The user can extend the work support function of the app by inputting an instruction in a natural language even without inputting any code, and hence the work support system 1 can increase convenience of the user. Details of the work support system 1 are described below.

### 3. Functions Implemented in Work Support System

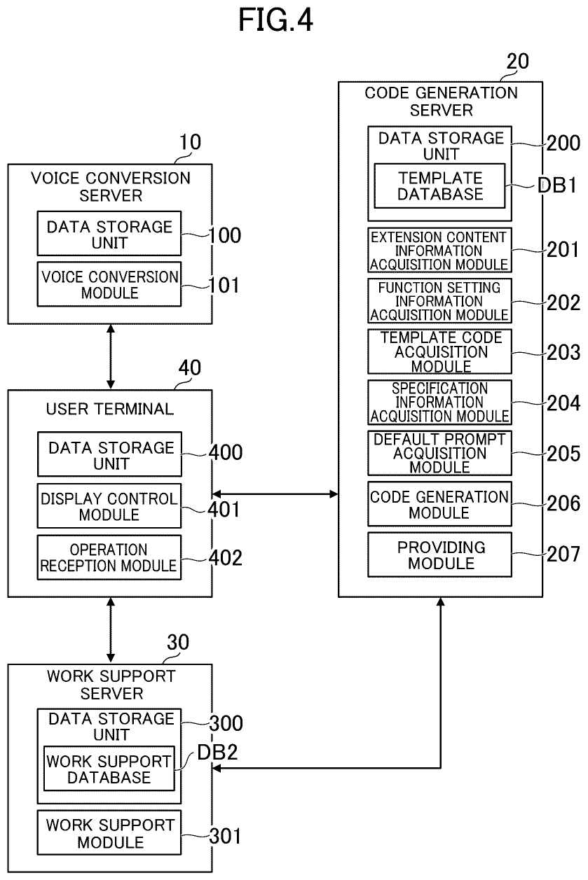

FIG. 4 is a diagram for illustrating an example of functions implemented in the work support system 1.

### [3-1. Functions Implemented in Voice Conversion Server]

For example, the voice conversion server 10 includes a data storage unit 100 and a voice conversion module 101. The data storage unit 100 is implemented by the storage unit 12. The voice conversion module 101 is implemented by the control unit 11. When voice input is not performed, the work support system 1 is not required to include the voice conversion server 10.

### [Data Storage Unit]

The data storage unit 100 stores data required for the voice conversion processing. For example, the data storage unit 100 stores a voice conversion program indicating the voice conversion processing. The voice conversion processing is at least one of processing for converting voice into text or processing for converting text into voice. In the at least one embodiment, a case in which the voice conversion processing includes both of those kinds of processing is taken as an example, but the voice conversion processing may be only any one of those kinds of processing. The voice conversion program for converting voice into text and the voice conversion program for converting text into voice may be separately provided. The voice conversion program may be a publicly-known program. For example, the voice conversion program may be a program of a pattern matching method using a voice waveform pattern, a machine learning method, or another method.

### [Voice Conversion Module]

The voice conversion module 101 executes the voice conversion processing based on the voice conversion program. For example, the voice conversion server 10 acquires input voice data indicating voice input by the user from the user terminal 40. A data format of the input voice data may be a publicly-known format. The voice conversion module 101 converts the voice input by the user into text based on the voice data and the voice conversion program. The voice conversion module 101 transmits input text data indicating text of the voice input by the user to the user terminal 40. The voice conversion module 101 may transmit the input text data to the code generation server 20, the work support server 30, or another computer.

For example, the voice conversion module 101 acquires answer text data indicating text of an answer from the AI from the code generation server 20, the work support server 30, or another computer. The voice conversion module 101 converts the text of the answer from the AI into voice based on the answer text data and the voice conversion program. The voice conversion module 101 transmits answer voice data indicating voice of the text of the answer from the AI to the user terminal 40. The user terminal 40 acquires the answer voice data from the voice conversion server 10. The user terminal 40 outputs the answer from the AI by voice from the voice output unit 47 based on the answer voice data. The user terminal 40 may acquire the answer text data from the voice conversion server 10, the code generation server 20, the work support server 30, or another computer. The user terminal 40 may display the answer from the AI in the display region A of the work support screen SC based on the answer text data.

### [3-2. Functions Implemented in Code Generation Server]

For example, the code generation server 20 includes a data storage unit 200, an extension content information acquisition module 201, a function setting information acquisition module 202, a template code acquisition module 203, a specification information acquisition module 204, a default prompt acquisition module 205, a code generation module 206, and a providing module 207. The data storage unit 200 is implemented by the storage unit 22. Each of the extension content information acquisition module 201, the function setting information acquisition module 202, the template code acquisition module 203, the specification information acquisition module 204, the default prompt acquisition module 205, the code generation module 206, and the providing module 207 is implemented by the control unit 21.

### [Data Storage Unit]

The data storage unit 200 stores data required for the code generation processing. For example, the data storage unit 200 stores a template database DB1.

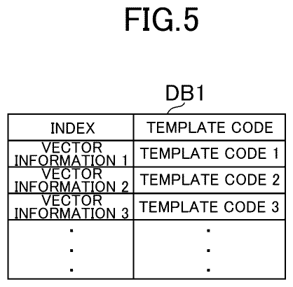

FIG. 5 is a table for showing an example of the template database DB1. For example, the template database DB1 stores template codes and indices to be used in searching for a template code. The index is information to be referred to at a time of a search for a template code. In the at least one embodiment, a case in which vector information (embedded representation) indicating the meaning of text in a natural language is used as the index is taken as an example. The vector information may be acquired by a publicly-known method (for example, Word2Vec or FastText). The vector information may be an embedded representation calculated by an AI that generates code based on a template code.

In the at least one embodiment, an index associated with a certain template code is vector information on extension content of the function to be extended by the certain template code (that is, content of the function to be implemented by processing indicated by the template code). For example, a template code indicating processing for changing a background color of a record stores vector information on text such as “This is the code for changing the background color of a record” as the index. A template code indicating processing for changing a character size of a record stores vector information on text such as “This is the code for changing the character size of a record” as the index.

The vector information may be any information to be used in searching for a template code. The vector information may be information in which the template code itself is vectorized in place of the above-mentioned information in which the text is vectorized. In addition, the index is not limited to the vector information. The index may be any information to be referred to at the time of a search. For example, the index may be information having a format other than the vector. For example, the index may be a sequence, a matrix, a single numerical value, a combination of a plurality of numerical values, or other information that indicates a meaning in a natural language. The index may be text indicating description of the template code, a keyword relating to the template code, a category to which the template code belongs, or other information.

The template code is a code provided in advance. In the at least one embodiment, a case in which a business operator operating the work support system 1 provides the template code is taken as an example, but the template code may be provided by any person. For example, the user may provide the template code. The template code may be shared between users. The template code may be provided by another business operator cooperating with the business operator operating the work support system 1. The template code associated with a certain index is a code for implementing the extension of a function indicated by the certain index. The template code indicates processing for the extension content of the function.

For example, when the vector information on text such as “This is the code for changing the background color of a record” is stored as the index, the template code associated with the index indicates processing for changing the background color of a record (processing for identifying a specific HTML element and changing a style of the element). The template code includes a style tag for setting the color of a page to a predetermined color and a mathematical function for calling up the style tag. When the vector information on text such as “This is the code for changing the character size of a record” is stored as the index, the template code associated with the index indicates processing for changing the character size of a record (processing for identifying a specific HTML element and changing a size of the element). The template code includes a style tag for setting the character size of a page to a predetermined size and a mathematical function for calling up the style tag.

The data stored in the data storage unit 200 is not limited to the above-mentioned example. The data storage unit 200 can store any data. In the at least one embodiment, a case in which the code generation server 20 uses the AI of an external service that cooperates with the work support system 1 is taken as an example, and hence it is assumed that the data storage unit 200 does not store the AI itself, but the data storage unit 200 may store the AI itself. That is, in the at least one embodiment, a case in which actual data of the AI is stored in a system for another service is taken as an example, but the data storage unit 200 may store the actual data of the AI.

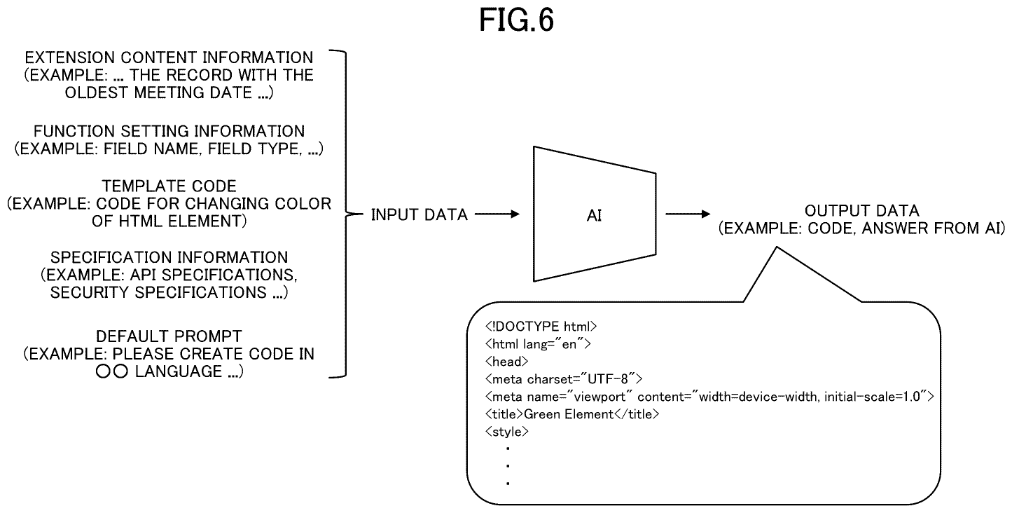

FIG. 6 is a diagram for illustrating an example of the AI used in generation of code. For example, the AI includes: a program indicating a series of processing steps such as calculation of an embedded representation; and parameters to be referred to by the program. The embedded representation is information for the AI to understand the meaning of data. For example, the embedded representation is represented by a multidimensional vector. The embedded representation may also be called a feature amount indicating a feature of data. The embedded representation may be represented in another format other than the multidimensional vector. The AI may include other data (for example, data equivalent to a dictionary of terms) other than the parameters. The other data is referred to by the program. The other data may be data separate from the AI. The AI calculates the embedded representation of input data input to itself based on the parameters, and performs output corresponding to the embedded representation. For example, the parameters are weights and biases.

The program and parameters of the AI may be a publicly-known program and publicly-known parameters, respectively. For example, the program and parameters of the AI may be a program and parameters employed in a large language model, such as a generative pre-trained transformer (GPT) or bidirectional encoder representations from transformers (BERT), a program and parameters employed in a machine learning model, such as a neural network or generative adversarial networks (GAN), a program and parameters employed in a generative AI or a conversational AI that is not classified into those, or another program and other parameters. The program and parameters of the AI may be selected from various programs and parameters that can be understood by a person skilled in the field of computer software based on the common general technical knowledge at the time of filing.

In the at least one embodiment, a large language model (for example, GPT) is described as an example of the AI, and hence the program of the AI indicates processing for analyzing input data input to the AI. The parameters of the AI are parameters such as weights and biases that are referred to by the AI to analyze the meaning in a natural language. The AI performs language analysis on the input data input to itself based on the parameters adjusted by training, and performs output corresponding to a result of the language analysis. For example, the AI divides the text in a natural language indicated by the input data into a plurality of tokens. The AI calculates the embedded representations indicating the meanings of the individual tokens based on the parameters. The AI understands the meaning in a natural language based on a sequential order of the embedded representations of the respective tokens. The AI may make a prediction based on the sequential order of the embedded representations of the respective tokens as required. The AI outputs output data corresponding to the sequential order of the embedded representations.

In the at least one embodiment, a case in which various codes have been learned by the AI is taken as an example. The AI may learn only a code (for example, JavaScript (trademark)) that can be handled by the work support system 1, but in the at least one embodiment, it is assumed that other codes have been learned as well. The AI may be capable of handling codes in various languages. For example, the output data from the AI may differ depending on the input data. When the input data is some question, the output data indicates an answer to the question. When the input data is an instruction to generate code, the output data includes the code. In this case, the output data may include not only the code but also an explanation of the code. The output data may include any type of information.

As in FIG. 6, in the at least one embodiment, a case in which the input data to the AI includes extension content information, function setting information, a template code, specification information, and a default prompt is taken as an example. Details of those pieces of information included in the input data are described later. The input data is only required to include at least the extension content information. The input data is not limited to the example in the at least one embodiment. For example, at least one of the function setting information, the template code, the specification information, or the default prompt may not be included in the input data. The output data from the AI is code. The output data may include code and information (for example, the answer from the AI) other than the code. The output data from the AI may not be code but may be intermediate code to be used to generate code that is ultimately provided to the user.

### [Extension Content Information Acquisition Module]

The extension content information acquisition module 201 acquires extension content information relating to extension content of the work support function in the work support system 1 based on the input of the user. In the at least one embodiment, a case in which the user inputs voice from the voice input unit 46 is taken as an example, but the user may also perform the input from the operating unit 44. For example, the user may input an instruction to the AI from the operating unit 44. The user may perform the input by selecting a part (for example, an image such as a button or a check box) serving as a user interface.

The extension content information is an instruction to the AI. The extension content information can also be said to be an intention of the user. The extension content information may also be called a prompt for the AI. Among the pieces of information included in the input data, other pieces of information other than the extension content information can also be said to be supplementary information to be input to the AI together with the prompt. There are various definitions of the term “prompt,” but when the information to be input to the AI corresponds to a prompt, other pieces of information other than the extension content information also correspond to prompts. The definition of the term “prompt” may be any one of various publicly-known definitions. In the at least one embodiment, the AI is used for the extension of the work support function, and hence the extension content information indicates content with which the user wishes to extend the work support function (content of customization that the user wishes). The extension content information is written in a natural language, but may be information in which the meaning in a natural language is vectorized.

In the at least one embodiment, a case in which text input in the input form F when the user selects the button B corresponds to the extension content information is taken as an example. Thus, the extension content information is text indicating specific content with which the user wishes to extend the work support function. When the user selects the button B, the user terminal 40 transmits the extension content information, which is the text input in the input form F, to the code generation server 20. The extension content information acquisition module 201 acquires the extension content information from the user terminal 40. The extension content information acquisition module 201 may acquire only one piece of extension content information, or may acquire a plurality of pieces of extension content information.

The extension content information may not be text in a natural language but may be the voice itself that has been used in the input by the user. In this case, the extension content information acquisition module 201 may acquire the extension content information, which is the voice, from the user terminal 40 and then request the voice conversion server 10 to convert the extension content information into text. The extension content information acquisition module 201 acquires the extension content information converted into text from the voice conversion server 10. In the at least one embodiment, the AI is a large language model, and hence the information converted into text is input to the AI. The extension content information acquisition module 201 may acquire the extension content information indirectly through the voice conversion server 10, the work support server 30, or another computer, instead of acquiring the extension content information directly from the user terminal 40.

### [Function Setting Information Acquisition Module]

The function setting information acquisition module 202 acquires function setting information relating to a setting of the work support function. The function setting information indicates the setting of the work support function to be extended. In the examples of FIG. 2 and FIG. 3, the database function of the app selected by the user corresponds to the work support function to be extended. The app selected by the user is the app (in the examples of FIG. 2 and FIG. 3, “meeting minutes management app”) displayed on the work support screen SC when the expansion content information is acquired. Thus, the function setting information indicates the setting of the app selected by the user. The function setting information acquisition module 202 may acquire only one piece of function setting information, or may acquire a plurality of pieces of function setting information.

In the at least one embodiment, the setting data on the app selected by the user is stored in a work support database DB2 described later, and hence the function setting information acquisition module 202 acquires, as the function setting information, at least one item in the setting data stored in the work support database DB2. The function setting information acquisition module 202 may acquire all items in the setting data as the function setting information, but in the at least one embodiment, the function setting information acquisition module 202 acquires field setting items of the app selected by the user in the setting data as the function setting information. It is assumed that the function setting information acquisition module 202 does not acquire other items in the setting data, such as an access right setting, as the function setting information.

For example, when the user selects the button B with the text having been input in the input form F of the work support screen SC, the function setting information acquisition module 202 acquires an app ID of the app selected by the user from the user terminal 40. The app ID is assumed to be included in display data (for example, HTML data) on the work support screen SC. The app ID may be included as part of a URL (for example, an argument included in a link for the button B). It suffices that the function setting information acquisition module 202 acquires the app ID of the app to be extended in some way. The function setting information acquisition module 202 may acquire the app ID of the app selected by the user from the voice conversion server 10, the work support server 30, or another computer.

For example, the function setting information acquisition module 202 requests the work support server 30 for the function setting information based on the app ID of the app selected by the user. It is assumed that the request includes the app ID. When the work support server 30 receives the request, the work support server 30 refers to the work support database DB2 to acquire setting data associated with the app ID. The work support server 30 acquires at least part of the setting data (for example, the field setting items) as the function setting information. The work support server 30 transmits the function setting information to the code generation server 20. The function setting information acquisition module 202 acquires the function setting information from the work support server 30.

In the examples of FIG. 2 and FIG. 3, the meeting minutes management app selected by the user has seven fields including “Record Number,” “Meeting Date,” “Meeting Time,” “Attendees,” “Agenda,” “Decision,” and “Next Step.” The function setting information acquisition module 202 acquires the function setting information including field codes, field names, field types, and a sequential order of those seven fields or a combination of those of the seven fields. When other setting items are present as the field setting items, the function setting information acquisition module 202 may acquire the function setting information including the other setting items.

It is assumed that the function setting information indicates a setting corresponding to the work support function to be extended. The function setting information is not limited to the example in the at least one embodiment. For example, the function setting information may indicate another setting other than the field setting of the app. The function setting information may indicate an app name, a note for an administrator who manages the app, a layout of a form for the user to input data, a display format of the list L, a format of a graph to be displayed based on data stored in the app, an icon of the app, another design of the app, a notification setting, an access right setting, or another setting.

In addition, when the user is to extend another database function other than the app, it suffices that the function setting information acquisition module 202 acquires function setting information indicating a setting of the other database function. When the user is to extend the communication function, it suffices that the function setting information acquires the function setting information indicating a setting of the communication function (for example, a thread name, a setting for copying information such as a comment in a thread, or a layout of a thread).

For example, when the user is to extend the schedule function, it suffices that the function setting information indicating a setting of the schedule function (for example, a setting of users who use the schedule function, a setting of facilities such as meeting rooms to be reserved by the schedule function, or a layout of a screen for the schedule function) is acquired as the function setting information. When the user is to extend the email management function, it suffices that the function setting information indicating a setting of the email management function (for example, a folder name for emails, a setting for sorting into folders, or a layout of a screen for the email management function) is acquired as the function setting information. Those pieces of function setting information are assumed to be stored in the work support database DB2.

### [Template Code Acquisition Module]

The template code acquisition module 203 acquires a template code relating to the work support function, the template code being provided in advance. In the at least one embodiment, the template codes are stored in the template database DB1, and hence the template code acquisition module 203 acquires a template code from the template database DB1. The template code acquisition module 203 may acquire the template code from another database other than the template database DB1, another computer other than the code generation server 20, or an external information storage medium. The template code acquisition module 203 may acquire only one template code, or may acquire a plurality of template codes.

In the at least one embodiment, the template code acquisition module 203 acquires the template code by searching the template database DB1, in which a plurality of template codes are stored, based on the extension content information. For example, the template code acquisition module 203 uses the extension content information as a query to search the template database DB1. The template code acquisition module 203 acquires a template code hit by the search among the template codes stored in the template database DB1. A search algorithm may be the same as an algorithm employed by a publicly-known search engine or the like.

For example, the template code acquisition module 203 acquires vector information on the text in a natural language indicated by the extension content information. Vectorization of the text in a natural language may be performed by a publicly-known method (for example, Word2Vec or FastText). The template code acquisition module 203 acquires a template code associated with a piece of vector information that is close in distance to the vector information on the text in a natural language indicated by the extension content information, among the pieces of vector information stored as the indices in the template database DB1.

For example, the template code acquisition module 203 may acquire a template code associated with a piece of vector information having the shortest distance from the vector information on the text in a natural language indicated by the extension content information. The template code acquisition module 203 may acquire a template code associated with a piece of vector information having a distance from the vector information on the text in a natural language indicated by the extension content information that is smaller than a threshold value. The template code acquisition module 203 may acquire a predetermined number of template codes in ascending order of the distance from the vector information on the text in a natural language indicated by the extension content information. With the vector information being used as the index, the template code acquisition module 203 can acquire a template code that meets the intention of the user even when there is no match as a keyword, thereby enabling a more flexible search.

A method by which the template code acquisition module 203 acquires the template code is not limited to the above-mentioned example. It suffices that the template code acquisition module 203 acquires the template code provided in advance. For example, the template code acquisition module 203 may acquire the template code by executing a search based on another index (for example, a keyword) other than the vector information. The template code acquisition module 203 may acquire the template code provided in advance without particularly executing a search. For example, the template code acquisition module 203 may acquire all the template codes provided in advance, or may acquire a template code selected at random. The template code acquisition module 203 may acquire a template code selected by the user from among the plurality of template codes.

### [Specification Information Acquisition Module]

The specification information acquisition module 204 acquires specification information relating to specifications required of the code. The specifications required of the code are specifications determined by the business operator operating the work support system 1. The specification required of the code can also be said to be a guideline that defines a requirement for the code. For example, the specification required of the code may be API specifications of the work support system 1, specifications specified in coding guidelines, specifications specified in security guidelines, specifications of a character code that can be used in the work support system 1, specifications of variables that can be used in the work support system 1, specifications of an attribute of a class or an ID, specifications of a description format of the URL, or other specifications. It is assumed that those specifications are described in a natural language, but the specifications described in a natural language may be vectorized.

It suffices that the specification information is information indicating details of specifications. For example, the specification information includes text indicating the specifications required of the code. That is, the specification information is information in which the details of the specifications are described in a natural language. The specification information may have any format. For example, the specification information may be a text file, a rich text file, a document file, or an HTML file, or may have another format. The specification information may include another element such as a table or a drawing in addition to the text. In the at least one embodiment, a case in which the data storage unit 200 stores the specification information is taken as an example. For example, the specification information acquisition module 204 refers to the data storage unit 200 to acquire the specification information. The specification information acquisition module 204 may acquire the specification information from another computer other than the code generation server 20 or an external information storage medium. The specification information acquisition module 204 may acquire only one piece of specification information, or may acquire a plurality of pieces of specification information.

For each work support function, the specification information specific to the work support function may be provided. For example, the specification information on the app and the specification information on functions other than the app, that is, the specification information on the database function, the specification information on the communication function, the specification information on the schedule function, and the specification information on the email management function may be provided separately from each other. It suffices that the specification information acquisition module 204 acquires the specification information on the work support function to be extended among a plurality of work support functions.

### [Default Prompt Acquisition Module]

The default prompt acquisition module 205 acquires a default prompt relating to the generation of code, the default prompt being provided in advance. In the at least one embodiment, a case in which the default prompt is provided by the business operator operating the work support system 1 is taken as an example, but the default prompt may be provided by any person. For example, the user may provide the default prompt, or another user in an organization to which the user belongs may provide the default prompt. The default prompt may be shared between users. The default prompt may be provided by another business operator cooperating with the business operator operating the work support system 1.

In the at least one embodiment, a case in which the data storage unit 200 stores the default prompt is taken as an example. For example, the default prompt acquisition module 205 refers to the data storage unit 200 to acquire the default prompt. The default prompt acquisition module 205 may acquire the default prompt from another computer other than the code generation server 20 or an external information storage medium. The default prompt acquisition module 205 may acquire only one default prompt, or may acquire a plurality of default prompts. The default prompt acquisition module 205 may acquire a default prompt corresponding to the extension content information among a plurality of default prompts.

For example, the AI may be capable of generating code in various languages. Meanwhile, the work support system 1 may only support a specific language (for example, JavaScript (trademark)). In this case, the user may not designate the specific language. For that reason, text indicating that the AI is to generate code in a specific language may be provided as the default prompt. Such a default prompt enables the AI to identify in which language the code is to be generated.

For example, the default prompt may be text indicating a role to be played by the AI, such as “You are an AI that supports the user in creating code.” Such a default prompt enables the AI to identify the role to be played by itself. For another example, the default prompt may be text indicating that the AI is to give some kind of answer to the user together with the code, such as “Please explain the code you have generated.” Such a default prompt enables the AI to identify that the AI is to generate an answer (for example, an explanation of the code) to the user together with the code.

For example, the default prompt may be text indicating what kind of information each of the extension content information, the function setting information, the template code, and the specification information is. The default prompt may be text such as “This information is the extension content information indicating the extension content that the user wishes. Please generate code that meets the wish of the user based on this information.” Such a default prompt enables the AI to identify that the extension content information indicates the wish of the user. In the same manner, for each of the function setting information, the template code, and the specification information, the default prompt may be text indicating details of the stated information. Such a default prompt enables the AI to identify how to use each of the function setting information, the template code, and the specification information.

### [Code Generation Module]

The code generation module 206 executes the code generation processing. The code generation processing is processing for generating code. The code generation module 206 generates code for the extension of the work support function based on the extension content information and the AI. For example, the code generation module 206 inputs the input data including the extension content information to the AI. In the at least one embodiment, the AI is stored in an external system, and hence the code generation module 206 transmits the input data to the external system. When the AI is stored in the data storage unit 200, the code generation module 206 is only required to input the input data to the AI stored in the data storage unit 200.

For example, the AI calculates the embedded representation of the input data based on parameters adjusted by previously performed training. In the at least one embodiment, a case in which a large language model exemplified by GPT corresponds to the AI is taken as an example, and hence the AI divides the input data into tokens and calculates the embedded representations of the individual tokens based on the parameters. The AI predicts a continuation based on the sequential order of the embedded representations of the tokens as required. The AI outputs the code as the output data based on the sequential order. For example, the AI may generate code based on a publicly-known function called a code interpreter that generates code from learning results in various languages. The AI may output the output data including not only the code but also the text of the answer to the user. The code generation module 206 generates code corresponding to the extension content information by acquiring the code included in the output data output by the AI.

For example, the extension content information is acquired based on the input of the user, and hence the extension content of the work support function that the user wishes is indicated in the extension content information. In the examples of FIG. 2 and FIG. 3, the extension content information indicates such specific content as to turn the record with the oldest meeting date green. The AI can understand such extension content information by language analysis and generate code for the extension of the work support function to be extended. The AI generating code for the extension of the function of the no-code or low-code work support system 1 is a novel configuration at the time of filing, but a technology publicly known at the time of filing may be used as a technology itself for the AI to generate code based on a prompt. Thus, a person skilled in the art can understand the processing in which the AI generates code in the at least one embodiment to a degree that the processing can be implemented based on the description of the at least one embodiment and the common general technical knowledge at the time of filing.

In the at least one embodiment, the code generation module 206 generates code further based on the function setting information. For example, the code generation module 206 inputs the input data including the extension content information and the function setting information to the AI. The AI calculates the embedded representation based on not only the extension content information but also the function setting information. The embedded representation reflects not only the extension content information but also the setting indicated by the function setting information. The AI outputs the output data including code corresponding to the calculated embedded representation. The code generation module 206 acquires the code included in the output data output by the AI, to thereby generate code corresponding to the function setting information.

For example, when the function setting information indicates the field setting items of the app selected by the user, the AI identifies for which field the processing is to be executed based on the embedded representation corresponding to each of the field setting items indicated by the function setting information. The AI generates code indicating the processing for the identified field. In the examples of FIG. 2 and FIG. 3, the AI identifies that the processing is required for the meeting date field from the embedded representation corresponding to the extension content information. The AI identifies that the app selected by the user includes a meeting date field from the embedded representation corresponding to the function setting information, and identifies that the processing for the field is to be executed. The AI generates output data including code indicating the processing for the meeting date field based on those identification results.

In the at least one embodiment, the code generation module 206 generates code further based on the template code. For example, the code generation module 206 inputs the input data including the extension content information and the template code to the AI. The AI calculates the embedded representation based on not only the extension content information but also the template code. The embedded representation reflects not only the extension content information but also the setting indicated by the template code. The AI outputs the output data including code corresponding to the calculated embedded representation. The code generation module 206 acquires the code included in the output data output by the AI, to thereby generate code corresponding to the template code.

For example, when the template code corresponding to the extension content information is acquired, the AI roughly identifies, for the code generation module 206, what kind of code is to be generated based on the embedded representation corresponding to the template code corresponding to the extension content information. The AI generates code corresponding to the extension content information based on the roughly identified code. In the examples of FIG. 2 and FIG. 3, the template code indicating the processing for changing the background color of a record is acquired. The AI roughly identifies what kind of code is required for changing the background color of a record based on the template code, and generates output data including the code for changing the background color of the record with the oldest meeting date.

In the at least one embodiment, the code generation module 206 generates code further based on the specification information. For example, the code generation module 206 inputs the input data including the extension content information and the specification information to the AI. The AI calculates the embedded representation based on not only the extension content information but also the specification information. The embedded representation reflects not only the extension content information but also the setting indicated by the specification information. The AI outputs the output data including code corresponding to the calculated embedded representation. The code generation module 206 acquires the code included in the output data output by the AI, to thereby generate code corresponding to the specification information.

For example, when the specification information indicates the API specification of the work support system 1, the AI roughly identifies, for the code generation module 206, of what kind of specification the code is to be generated based on the embedded representation corresponding to the API specification that meets the specification information. The AI generates code that meets the specification information based on the roughly identified specification. In the examples of FIG. 2 and FIG. 3, the work support function to be extended is an app, and hence the specification information indicates the API specification of the app. The AI identifies the API specification of the app based on the specification information, and generates output data including code that satisfies the specification.

In the at least one embodiment, the code generation module 206 generates code further based on the default prompt. For example, the code generation module 206 inputs the input data including the extension content information and the default prompt to the AI. The AI calculates the embedded representation based on not only the extension content information but also the default prompt. The embedded representation reflects not only the extension content information but also the setting indicated by the default prompt. The AI outputs the output data including code corresponding to the calculated embedded representation. The code generation module 206 acquires the code included in the output data output by the AI, to thereby generate code corresponding to the default prompt.

For example, when a language of code to be generated by the AI is indicated in the default prompt, the AI identifies, for the code generation module 206, in which language the code is to be generated based on the embedded representation corresponding to the default prompt. The AI generates code in the language. In the examples of FIG. 2 and FIG. 3, code is required to be generated in a language that enables the code to be executed on the browser of the user terminal 40, and hence the language is indicated in the default prompt. The AI identifies a language of code to be generated by the AI itself based on the default prompt, and generates output data including the code in the language.

The code generation module 206 may generate code based on the input data including other information. For example, the code generation module 206 may generate code based on the input data including not only the function setting information on the app selected by the user but also data stored in a record of the app. The code generation module 206 may generate code based on the input data including user information relating to a user himself or herself. The user information may be a profile of the user, an organization to which the user belongs, or other information.

### [Providing Module]

The providing module 207 provides the code to the user. The providing module 207 providing the code means that the providing module 207 transmits data indicating the code itself or data indicating an execution result of the code to the user terminal 40. The providing module 207 may transmit those kinds of data directly to the user terminal 40, or may transmit those kinds of data indirectly through another computer such as the work support server 30. In the at least one embodiment, the code is executed on the browser of the user terminal 40, and hence a case in which the providing module 207 transmits the data indicating the code itself (for example, HTML data including the code) to the user terminal 40 is taken as an example.

In the at least one embodiment, the code generated by the code generation module 206 is deployed by the work support server 30, and then transmitted to the user terminal 40. The deployment is deployment to the work support function to be extended. In the examples of FIG. 2 and FIG. 3, the deployment is deployment of the code to the app selected by the user. For example, the providing module 207 requests the work support server 30 to deploy the code generated by the code generation module 206. When the work support server 30 receives the request for the deployment, the work support server 30 deploys the code as requested by the code generation server 20. For example, the work support server 30 deploys the code by embedding the code in the display data (e.g., HTML data) on the work support screen SC. The code may be embedded at any location in the display data.

For example, the providing module 207 provides the code to the user by executing processing for displaying a screen indicating a deployment result of the code on the user terminal 40 of the user. The work support screen SC in the lower half of FIG. 3 is an example of the screen indicating the deployment result of the code. Thus, the work support screen SC in the lower half of FIG. 3 as described herein can be read as the screen indicating the deployment result of the code. The screen indicating the deployment result of the code is only required to be a screen of the work support function to be extended. The method itself for the deployment may be a publicly-known method. For example, the work support server 30 may execute the code and transmit only the data indicating the execution result thereof to the user terminal 40.

In the at least one embodiment, a case in which the providing module 207 requests the work support server 30 to deploy the code is taken as an example, but the providing module 207 may request another computer other than the work support server 30 to deploy the code. For example, when the user terminal 40 has a deployment function, the providing module 207 may provide the code to the user by requesting the user terminal 40 to deploy the code. The providing module 207 may provide the code to the user by deploying the code by itself and causing the user terminal 40 to display the work support screen SC indicating the deployment result of the code. The providing module 207 may provide the code to the user by simply transmitting only the data indicating the code to the user terminal 40 without particularly executing the deployment.

For example, when the user confirms that the extension of the function that meets his or her own wish has been performed, the user performs the operation for ending the generation of code. In this case, the work support server 30 stores the code in a data storage unit 300 in association with the user. The user can use the code stored in the data storage unit 300 from the next time onward. For example, when the user calls up again the app for which the code has been generated by the AI, the display data on the work support screen SC of the app already includes the code. The user can also correct or delete the code stored in the data storage unit 300.

### [3-3. Functions Implemented in Work Support Server]

For example, the work support server 30 includes the data storage unit 300 and a work support module 301. The data storage unit 300 is implemented by the storage unit 32. The work support module 301 is implemented by the control unit 31.

### [Data Storage Unit]

The data storage unit 300 stores data required for the work support processing. For example, the data storage unit 300 stores the work support database DB2 in which various kinds of data on the work support system 1 are stored. In the at least one embodiment, a scene in which the user extends the function of the app is taken as an example, and hence a case in which various kinds of data on the app are stored in the work support database DB2 is taken as an example.

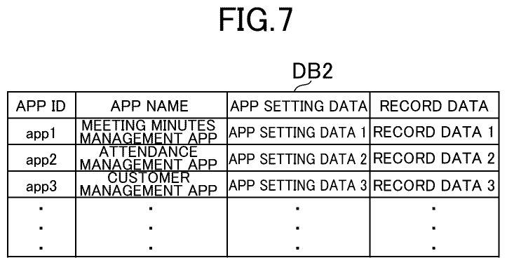

FIG. 7 is a table for showing an example of the work support database DB2. For example, the work support database DB2 stores an app ID, an app name, app setting data, and record data. The data stored in the work support database DB2 is not limited to the example of FIG. 7. For example, the work support database DB2 may store other data (for example, data on conversation threading in which users communicate with each other, data on schedules, or data on emails) other than the app.

The app ID is an ID that can identify the app. The app name is a name of the app. The app setting data indicates the setting of the app designated by the user with no-code or low-code. For example, the app setting data may be the above-mentioned field setting, a graph setting, a display setting of the list L, an access right setting, or another setting. The code generated by the AI may be saved as part of the app setting data. The record data is data stored in a record. When the user creates a new app, data such as the app ID of the new app is stored in the work support database DB2. When the user updates the app, the data on the app in the work support database DB2 is updated.

The data stored in the data storage unit 300 is not limited to the above-mentioned example. It suffices that the data storage unit 300 stores data required for supporting work. For example, the data storage unit 300 may store data (for example, HTML data or image data) required for displaying the work support screen SC, or may store data (for example, a deployment program) required for deploying the code.

### [Work Support Module]

The work support module 301 executes the work support processing for supporting work of users. The work support processing is processing for providing the work support function to the user. For example, the work support processing is processing for displaying the work support screen SC on the user terminal 40. In the at least one embodiment, the function of the app is extended by the code generated by the code generation server 20, and hence the work support processing may be processing for deploying the code generated by the AI and displaying a result thereof on the work support screen SC. Details of the processing for displaying the work support screen SC and the processing for deploying the code generated by the AI are as described above.

### [3-4. Functions Implemented in User Terminal]

For example, the user terminal 40 includes a data storage unit 400, a display control module 401, and an operation reception module 402. The data storage unit 400 is implemented by the storage unit 42. Each of the display control module 401 and the operation reception module 402 is implemented by the control unit 41.

### [Data Storage Unit]

The data storage unit 400 stores data for the work support. For example, the data storage unit 400 stores a browser for displaying various screens of the work support system 1. For example, the data storage unit 400 stores an application dedicated to the work support system 1. The data storage unit 400 stores the display data on the work support screen SC.

### [Display Control Module]

The display control module 401 displays various screens in the work support system 1 on the display unit 45. For example, the display control module 401 displays the work support screen SC on the display unit 45 based on data received from the voice conversion server 10, the code generation server 20, or the work support server 30.

### [Operation Reception Module]

The operation reception module 402 receives various operations in the work support system 1. For example, the operation reception module 402 receives operations on the work support screen SC. Data indicating the operation content received by the operation reception module 402 is transmitted to the voice conversion server 10, the code generation server 20, or the work support server 30 as appropriate.

### 4. Processing Executed in Work Support System

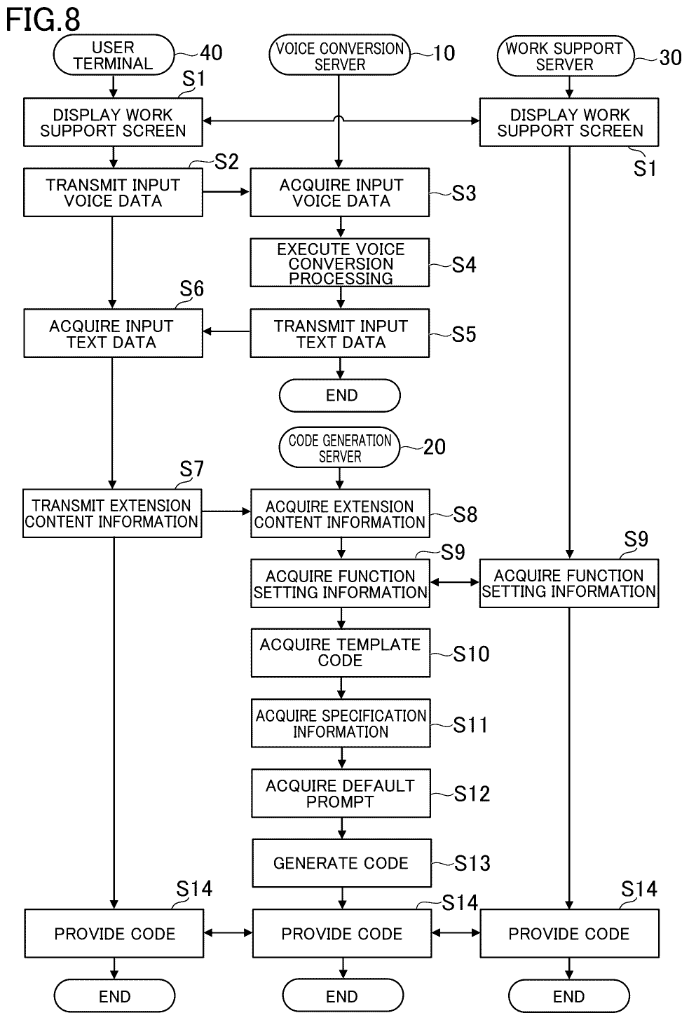

FIG. 8 is a flowchart for illustrating an example of processing executed in the work support system 1. The processing of FIG. 8 is executed by the control units 11, 21, 31, and 41 executing the programs stored in the storage units 12, 22, 32, and 42, respectively. Respective processing steps of FIG. 8 are examples of processing steps included in the work support method. In FIG. 8, an example of processing performed so as to extend the work support function of the app is illustrated. In FIG. 8, the user terminal 40 may communicate indirectly to/from each of the voice conversion server 10 and the code generation server 20 through the work support server 30 instead of directly communicating to/from each thereof.

As illustrated in FIG. 8, the user terminal 40 executes, between the user terminal 40 and the work support server 30, the processing for displaying the work support screen SC of the app selected by the user (Step S1). In Step S1, the work support server 30 generates display data on the work support screen SC of the app selected by the user based on the work support database DB2, and transmits the display data to the user terminal 40. When the user terminal 40 receives the display data on the work support screen SC, the user terminal 40 displays the work support screen SC on the display unit 45. After that, the user extends the work support function of the app in accordance with the flow of FIG. 2 and FIG. 3.

When the user terminal 40 receives input of voice from the user through the voice input unit 46, the user terminal 40 transmits the input voice data indicating the voice input by the user to the voice conversion server 10 (Step S2). The voice conversion server 10 acquires the input voice data from the user terminal 40 (Step S3). The voice conversion server 10 executes the voice conversion processing based on the voice conversion program and the input voice data (Step S4). The voice conversion server 10 transmits the input text data indicating the text of the voice input by the user (Step S5). The user terminal 40 acquires the input text data from the voice conversion server 10 (Step S6).

When the user selects the button B, the user terminal 40 transmits the extension content information to the code generation server 20 (Step S7). In Step S7, the user terminal 40 requests the code generation server 20 to generate code. In Step S7, the app ID of the app to be extended is transmitted as well. The code generation server 20 acquires the extension content information from the user terminal 40 (Step S8). The code generation server 20 executes, between the code generation server 20 and the work support server 30, processing for acquiring the function setting information (Step S9). In Step S9, the code generation server 20 transmits the app ID of the app to be extended to the work support server 30. The work support server 30 acquires the function setting information required for the generation of code based on the app setting data associated with the app ID based on the work support database DB2. The work support server 30 transmits the function setting information to the code generation server 20. The code generation server 20 acquires the function setting information from the work support server 30.

The code generation server 20 acquires the template code based on the template database DB1 (Step S10). In Step S10, the code generation server 20 searches the template database DB1 based on the extension content information. The code generation server 20 acquires the template code hit by the search. The code generation server 20 acquires the specification information stored in the storage unit 22 (Step S11). The code generation server 20 acquires the default prompt stored in the storage unit 22 (Step S12). The code generation server 20 generates code based on the AI and the input data including the respective pieces of information acquired in Step S8 to Step S12 (Step S13). In Step S13, the code generation server 20 transmits the input data to the external system managing the AI. The code generation server 20 acquires the output data including the code generated by the AI from the external system.

The code generation server 20 executes, between the work support server 30 and the user terminal 40, processing for providing the code to the user (Step S14), and the process ends. In Step S14, the code generation server 20 requests the work support server 30 to deploy the code generated in Step S13. The work support server 30 deploys the code, and generates display data on the work support screen SC. The work support server 30 transmits the display data on the work support screen SC to the user terminal 40. When the user terminal 40 receives the display data on the work support screen SC, the user terminal 40 executes the code included in the display data to display the work support screen SC on the display unit 45. When voice output of the answer from the AI is required, the voice conversion server 10 acquires data indicating the answer from the AI from the code generation server 20, and executes the processing for converting text into voice. The converted voice is output by the user terminal 40.

### 5. Summary of at Least One Embodiment

The work support system 1 according to the at least one embodiment can support work of users with no-code or low-code. The work support system 1 acquires the extension content information based on the input of the user. The work support system 1 generates code for the extension of the work support function based on the extension content information and the AI. The work support system 1 provides the code to the user. This enables the user to extend the work support function by performing input for causing the work support system 1 to acquire the extension content information even without inputting any code, and hence the work support system 1 can increase the convenience of the user. For example, the user of the no-code or low-code work support system 1 may have no knowledge of code or may not have much knowledge of code. The user can easily extend the work support function by the code generation processing of the work support system 1 without acquiring knowledge of code. Even the user with knowledge of code does not require time and labor to input code, and hence the work support system 1 can increase the convenience of the user with knowledge of code. For example, a non-AI code generation tool may be able to provide only limited functions to the user, and cannot meet various requests from users. The work support system 1 can meet various requests from users by utilizing the AI. The work support system 1 can generate code that enables customization that meets a specific request from each user.

The work support system 1 also acquires the function setting information. The work support system 1 generates code further based on the function setting information. This enables the work support system 1 to generate code corresponding to not only the input of the user but also the setting of the work support function to be extended. The work support system 1 generates code specific to the work support function that the user intends to extend, to thereby more easily generate code that meets the wish of the user. For example, in the examples of FIG. 2 and FIG. 3, the work support system 1 can generate code corresponding to the setting such as the field setting of the app that the user intends to extend, to thereby more easily generate the generation of code that meets the wish of the user.

The work support system 1 also acquires the template code. The work support system 1 generates code further based on the template code. This enables the work support system 1 to generate code that does not deviate from a format defined in advance. For example, when the work support system 1 generates code through use of a general-purpose AI, there is a possibility that the work support system 1 may generate code for a purpose different from the work support. The AI generates code based on the template code provided in the work support system 1, to thereby more easily generate code for the work support. That is, the AI can generate code corresponding to the extension content information by referring to the template code. The work support system 1 more easily generates code that meets the wish of the user.

The work support system 1 also acquires the template code by searching the template database DB1 in which a plurality of template codes are stored based on the extension content information. This enables the work support system 1 to more easily generate code that meets the wish of the user based on the template code corresponding to the extension content information. For example, the work support system 1 can search for a template code that meets the wish of the user and generate code based on the found template code, to thereby more easily generate code that meets the wish of the user.

The work support system 1 also acquires the specification information. The work support system 1 generates code further based on the specification information. This enables the work support system 1 to generate code that satisfies the specifications specific to the work support system 1. For example, there is a possibility that a general-purpose AI may generate general code irrespective of the specifications specific to the work support system 1. The AI can grasp the specifications specific to the work support system 1 based on the specification information, and hence the work support system 1 more easily generates code that meets the wish of the user. For example, the work support system 1 can generate code that meets security specifications, thereby enabling reduction of security risks.

The work support system 1 also acquires the default prompt. The work support system 1 generates code further based on the default prompt. This enables the work support system 1 to generate code after supplementing an item missing in the input of the user with the default prompt. For example, even when the user does not input a language in which the code is to be generated by the AI, the work support system 1 defines a specific language by the default prompt, to thereby be able to generate code in the language.

The work support system 1 also provides the code to the user by executing the processing for displaying the work support screen SC indicating the deployment result of the code on the user terminal 40. This enables the work support system 1 to allow the user to confirm the execution result of the code, thereby increasing the convenience of the user. The work support system 1 can execute a process from the generation of code to the deployment of the code in a single flow, thereby being able to accelerate the flow.

### 6. Modification Examples

The present disclosure is not limited to the at least one embodiment described above. The present disclosure can be modified as required without departing from the purport of the present disclosure.

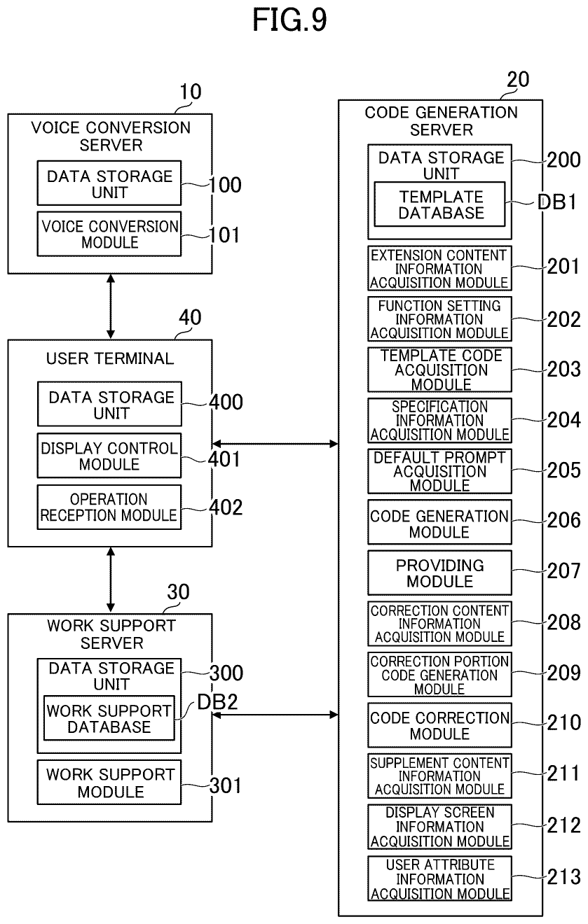

FIG. 9 is a diagram for illustrating an example of functions implemented in the work support system 1 according to modification examples. As illustrated in FIG. 9, in the modification examples described below, a correction content information acquisition module 208, a correction portion code generation module 209, a code correction module 210, a supplement content information acquisition module 211, a display screen information acquisition module 212, and a user attribute information acquisition module 213 are implemented. Each of the correction content information acquisition module 208, the correction portion code generation module 209, the code correction module 210, the supplement content information acquisition module 211, the display screen information acquisition module 212, and the user attribute information acquisition module 213 is implemented by the control unit 21.

### 6-1. Modification Example 1

For example, there may be a plurality of pieces of extension content with which to extend the work support function. In this case, the user may be able to successively specify pieces of extension content information with respect to the AI. In Modification Example 1, a case in which a function of turning a record with the most recent meeting date red and a function of duplicating a record including a specific user in the attendees are added to the app after the function of turning the record with the oldest meeting date green is added to the app as in FIG. 2 and FIG. 3 is taken as an example. The user is to perform the input three times in total.

The extension content information acquisition module 201 in Modification Example 1 acquires the extension content information each time the user performs new input. For example, under the state of the work support screen SC in the lower half of FIG. 3, the user performs voice input indicating that the record with the most recent meeting date is to be turned red. The AI generates code for turning the record with the most recent meeting date red based on the extension content information corresponding to the voice input by the user. After that, the user performs voice input indicating that the record including the specific user in the attendees is to be duplicated. The AI generates code for duplicating the record including the specific user in the attendees based on the extension content information corresponding to the voice input by the user. In this manner, the extension content information acquisition module 201 acquires the extension content information each time the user successively performs input.

The code generation module 206 in Modification Example 1 generates code further based on a history of the extension content information. The history of the extension content information is extension content information acquired based on input performed in the past. The history includes at least one piece of extension content information. The history of the extension content information is assumed to be stored in the data storage unit 200. The code generation module 206 acquires the history of the extension content information stored in the data storage unit 200, and generates code. The code generation module 206 may acquire the history of the extension content information from another computer such as the user terminal 40. At a time of the first input performed by the user, there is no history of the extension content information, and hence the code generation module 206 generates code based on a piece of extension content information at the time of the first input. This processing is as described in the at least one embodiment. At a time of the second input or the subsequent input performed by the user, the code generation module 206 generates code further based on the history of the extension content information.

For example, the code generation module 206 inputs, to the AI, the input data including a new piece of extension content information and the history of the extension content information. The AI calculates the embedded representation based on not only the new piece of extension content information but also the history of the extension content information. The embedded representation reflects not only the new piece of extension content information but also the history of the extension content information. The AI outputs the output data including code corresponding to the calculated embedded representation. The code generation module 206 acquires the code included in the output data output by the AI, to thereby generate code corresponding to the history.

For example, at the time of the second input performed by the user, the code generation module 206 inputs, to the AI, the input data including a new piece of extension content information corresponding to the second input and the piece of extension content information at the time of the first input, which is the history of the extension content information. At a time of the third input performed by the user, the code generation module 206 inputs, to the AI, the input data including a new piece of extension content information corresponding to the third input and pieces of extension content information at the respective times of the first and second inputs, which are the history of the extension content information. In the same manner, at a time of the fourth input or the subsequent input performed by the user, the code generation module 206 inputs, to the AI, the input data including a new piece of extension content information and the history of the extension content information corresponding to the inputs up to that point in time. The code generation module 206 acquires code included in the output data from the AI.

The work support system 1 according to Modification Example 1 acquires the extension content information each time the user performs new input. The work support system 1 generates code further based on the history of the extension content information. This enables the work support system 1 to generate code that takes into consideration not only the most recent input performed by the user but also the input performed in the past by the user, thereby being able to increase the convenience of the user. For example, while the user repeatedly performs input, the user may omit information that was previously input. The use of the history of the extension content information enables the work support system 1 to identify the information omitted by the user from the previous context and generate code.

### 6-2. Modification Example 2

For example, the AI may not be able to generate code that meets the wish of the users at once. For that reason, the user may be able to give an instruction to correct the code generated by the AI. In the examples of FIG. 2 and FIG. 3, the user may give an instruction to correct the code generated by the AI from the work support screen SC in the lower half of FIG. 3. In Modification Example 2, a case in which the user gives an instruction to correct the code by voice input is taken as an example, but the user may give an instruction to correct the code by any other input method. For example, the user may instruct the correction of the code by text input.

The user may explicitly instruct the work support system 1 to correct the code by voice input, text input, or another operation (for example, by selecting a “Correct” button). The work support system 1 can identify, based on the explicit instruction from the user, that the generated code is to be corrected rather than new code is to be generated. Even when the user does not give an explicit instruction to the work support system 1, the AI may infer that the code is to be corrected. The AI may identify, based on the input data, that the generated code is to be corrected rather than new code is to be generated. The AI can perform such identification through use of the embedded representation of the input data.

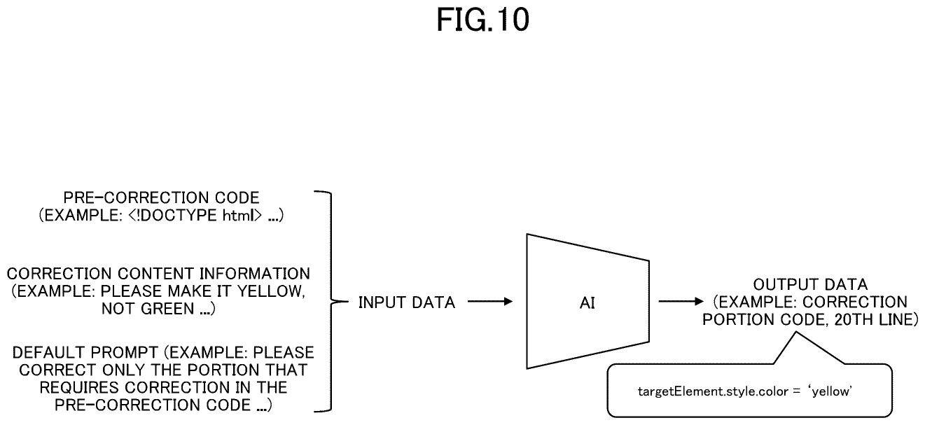

FIG. 10 is a diagram for illustrating an example of processing for the correction of the code. The work support system 1 according to Modification Example 2 includes the correction content information acquisition module 208 and the correction portion code generation module 209. The correction content information acquisition module 208 acquires correction content information relating to correction content of the code based on the input of the user. The correction content information is an instruction indicated by the input of the user at a time of the correction of the code. The correction content information can also be said to be the intention of the user at the time of the correction. The correction content information may also be called a prompt for the AI. As in FIG. 10, at the time of the correction, the input data including the correction content information is input to the AI.

In Modification Example 2, a case in which text input in the input form F when the user selects the button B at the time of the correction of the code corresponds to the correction content information is taken as an example. Thus, the correction content information is text indicating specific content with which the user wishes to correct the code. When the user selects the button B, the user terminal 40 transmits the correction content information, which is the text input in the input form F, to the code generation server 20. The correction content information acquisition module 208 acquires the correction content information from the user terminal 40. The correction content information acquisition module 208 may acquire only one piece of correction content information, or may acquire a plurality of pieces of correction content information.

The correction content information may not be text in a natural language but may be the voice itself that has been used in the input by the user. In this case, the correction content information acquisition module 208 may acquire the correction content information, which is the voice, from the user terminal 40 and then request the voice conversion server 10 to convert the correction content information into text. The correction content information acquisition module 208 acquires the correction content information converted into text from the voice conversion server 10. The correction content information acquisition module 208 may acquire the correction content information indirectly through the voice conversion server 10, the work support server 30, or another computer, instead of acquiring the correction content information directly from the user terminal 40.

The correction portion code generation module 209 generates correction portion code, which is post-correction code of a correction portion corresponding to the correction content in pre-correction code, based on the correction content information and the AI. The correction portion corresponding to the correction content is a portion in the pre-correction code. An amount of the correction portion varies depending on the correction content. For example, the correction portion may be only one line, or may be two or more lines. The correction portion may not be a certain set of consecutive lines. For example, the third and 10th lines of 20-line code may be the correction portions. Which portion is to be corrected is determined by the AI.

For example, the AI outputs, together with the correction portion code, correction portion identification information that can identify the correction portion in the pre-correction code. The correction portion identification information can also be said to be a location of the correction portion in the pre-correction code. For example, the correction portion identification information indicates which line the correction portion is on. As the default prompt at the time of the correction, a prompt such as “Please correct only the portion that requires correction in the pre-correction code. Please output the post-correction code of that portion and the identification information on that portion.” may be provided. Such a default prompt enables the AI to more accurately understand that it is only required to output the correction portion code and the correction portion identification information.

For example, the correction portion code generation module 209 inputs the input data including the pre-correction code and the correction content information to the AI. In the example of FIG. 10, the correction portion code generation module 209 inputs the input data further including the default prompt to the AI. The AI calculates the embedded representation based on not only the correction content information but also the pre-correction code. The embedded representation reflects not only the correction content information but also the pre-correction code. The AI outputs the output data including the correction portion identification information and the correction portion code corresponding to the calculated embedded representation. The code generation module 206 acquires the correction portion code and the correction portion identification information included in the output data output by the AI. In the example of FIG. 10, only the 20th line of the pre-correction code is output from the AI as the correction portion code. The correction portion identification information indicates that the correction portion is on the 20th line.

The code correction module 210 in Modification Example 2 corrects the code by replacing the correction portion in the pre-correction code by the correction portion code. The replacement can also be said to be overwriting or change. In the example of FIG. 10, the 20th line of the pre-correction code is replaced by the correction portion code. For example, the code correction module 210 replaces the correction portion indicated by the correction portion identification information in the pre-correction code by the correction portion code. The user may designate the correction portion. For example, the user may perform input such as “Please correct the code on the 20th line.” In this case, the correction content information includes the correction portion identification information. The AI may not output the correction portion identification information. Even when the AI does not output the correction portion identification information, the code correction module 210 is only required to replace the correction portion input by the user by the correction portion code.

The work support system 1 according to Modification Example 2 acquires the correction content information based on the input of the user. The work support system 1 generates a correction portion code based on the correction content information and the AI. The work support system 1 corrects the code by replacing the correction portion corresponding to the correction content in the code by the correction portion code. This enables the work support system 1 to increase the efficiency of a correction task for the code performed by the user, thereby increasing the convenience of the user at the time of the correction. For example, when the AI regenerates the entire code, there is a possibility that code indicating completely different processing from before the correction may be generated, but the work support system 1 replaces only the correction portion in the pre-correction code by correction portion code, thereby preventing the processing from becoming completely different from before the correction, for example, and increasing accuracy of the correction.

### 6-3. Modification Example 3

For example, the input of the user alone may not include enough information to generate code. For example, when the user performs input such as “Create a function of changing the record with the oldest meeting date,” it is not explicitly represented what the user wishes to change in the record. In recent years, there has been known an AI that infers and supplements missing information when the input of the user is insufficient. For example, a large language model exemplified by GPT may be able to infer the missing information by predicting a continuation of the input of the user. In the above-mentioned example, the AI may be able to supplement the missing information with information indicating that a color is to be changed. Even when the input of the user has some information missing, such an AI can generate code by inferring and supplementing the missing information. Meanwhile, the AI may perform inappropriate supplementation that does not meet the wish of the user. For that reason, when the AI has supplemented information, the fact of the supplementation may be displayed on the work support screen SC.

The work support system 1 according to Modification Example 3 includes the supplement content information acquisition module 211. When the AI has supplemented a portion missing in the extension content information to generate code, the supplement content information acquisition module 211 acquires supplement content information relating to supplement content provided by the AI. The supplement content is information missing in the input of the user. The supplement content can also be said to be content omitted from the explicit input of the user but inferred by the AI as the wish of the user. The AI supplements the input of the user by predicting a continuation of the natural language input by the user. The supplement content can also be said to be a result of the prediction performed by the AI.

For example, as the default prompt in Modification Example 3, a prompt such as “When the input of the user is insufficient, please supplement the information. Please output so that it is clear which information has been supplemented.” may be provided. The AI can output the supplement content information when such a default prompt is input. The supplement content information acquisition module 211 acquires the supplement content information output from the AI. A case in which the supplement content information is represented in text is taken as an example, but the supplement content information may be in voice or in another format.

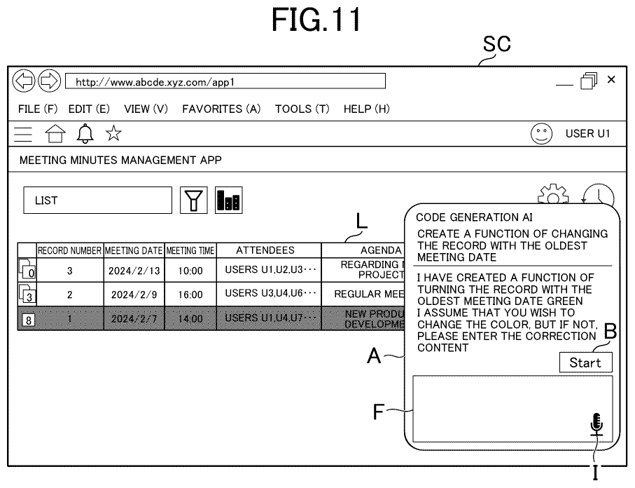

FIG. 11 is a view for illustrating an example of the work support screen SC in Modification Example 3. The providing module 207 further provides the supplement content to the user based on the supplement content information. In the example of FIG. 11, the AI has supplemented the color, and hence the providing module 207 provides the supplement content to the user by displaying the work support screen SC on which a message indicating the fact of the supplementation is displayed in the display region A. In the example of FIG. 11, a message such as “I assume that you wish to change the color, but if not, please enter the correction content” corresponds to the supplement content.

For example, the providing module 207 transmits the supplement content information to the work support server 30 and requests the work support server 30 to display the supplement content. When the work support server 30 receives the request, the work support server 30 generates the display data on the work support screen SC so that the supplement content indicated by the supplement content information is displayed on the work support screen SC. The work support server 30 transmits the display data on the work support screen SC indicating the supplement content to the user terminal 40. The user terminal 40 displays the work support screen SC as in FIG. 11 on the display unit 45 based on the display data. When the supplement content provided by the AI is as intended, the user ends the generation of code. When the supplement content provided by the AI is not as intended, the user corrects the code or starts the generation of code again from the beginning, for example.

The work support system 1 according to Modification Example 3 acquires the supplement content information when the AI has supplemented a portion missing in the extension content information to generate code. The work support system 1 further provides the supplement content to the user based on the supplement content information. This allows the user to know the supplement content provided by the AI through the supplementation, and hence the work support system 1 can increase the convenience of the user. For example, when the supplement content provided by the AI through the supplementation is incorrect, the incorrect portion is required to be corrected, and hence the user more easily grasps which portion to pay attention to and check.

### 6-4. Modification Example 4

For example, the work support system 1 may further include the display screen information acquisition module 212 that acquires display screen information relating to a screen displayed on the user terminal 40 when the input of the user is performed. The display screen information is information that can identify the screen currently displayed on the user terminal 40. The display screen information may have any format, and may be, for example, a URL of the currently displayed screen, an ID assigned to the currently displayed screen, a screenshot of the currently displayed screen, or other information. For example, the display screen information may be included in a request such as an HTTP request transmitted from the user terminal 40. The URL of the work support screen SC or part thereof may be used as the display screen information.

The code generation module 206 in Modification Example 4 may generate code further based on the display screen information. For example, the code generation module 206 may input the input data including the display screen information to the AI. The AI calculates the embedded representation based on not only the extension content information but also the display screen information. The embedded representation reflects not only the extension content information but also the feature of the display screen information. The AI outputs the output data including code corresponding to the calculated embedded representation. The code generation module 206 acquires the code included in the output data output by the AI, to thereby generate code corresponding to the display screen information.

The display screen information may not be used by the code generation module 206, but may be used by another function. For example, the specification information acquisition module 204 may acquire the specification information, which is described in the at least one embodiment, based on the display screen information. In the examples of FIG. 2 and FIG. 3, the display screen information may indicate the app ID that can identify the app. The specification information acquisition module 204 may acquire the specification information on the app indicated by the app ID based on the app ID indicated by the display screen information. The processing performed after the specification information acquisition module 204 has acquired the specification information is as described in the at least one embodiment.

The work support system 1 according to Modification Example 4 generates code further based on the display screen information. This enables s the work support system 1 to generate code corresponding to the work support screen SC displayed on the user terminal 40. For example, the work support system 1 can generate code specific to the app displayed on the work support screen SC. The work support system 1 can generate code specific to the specifications of the app currently displayed on the work support screen SC. The work support system 1 can generate code specific to the screenshot of the work support screen SC.

### 6-5. Modification Example 5

For example, the work support system 1 may further include the user attribute information acquisition module 213 that acquires user attribute information relating to attributes of the user. The user attribute information is information that enables classification of the user. Examples of the user attribute information may include the organization, organization size, department, job position, industry, profile, year of joining the company, age, gender, and other information of the user. The user attribute information may be information called demographic information.

In Modification Example 5, a case in which the data storage unit 300 of the work support server 30 stores a user database that stores the user attribute information is taken as an example. The user attribute information acquisition module 213 acquires the user attribute information from the user database. The user attribute information acquisition module 213 may acquire the user attribute information from another database other than the user database, another computer (for example, the code generation server 20) other than the work support server 30, or an external information storage medium. The user may be able to edit his or her own user attribute information.

The code generation module 206 in Modification Example 5 may generate code further based on the user attribute information. For example, the code generation module 206 inputs the input data including the user attribute information to the AI. The AI calculates the embedded representation based on not only the extension content information but also the user attribute information. The embedded representation reflects not only the extension content information but also the feature of the user attribute information. The AI outputs the output data including code corresponding to the calculated embedded representation. The code generation module 206 acquires the code included in the output data output by the AI, to thereby generate code corresponding to the user attribute information.

The work support system 1 according to Modification Example 5 generates code further based on the user attribute information. This enables the work support system 1 to generate code corresponding to the attributes of the user. For example, when code suitable for supporting the work of a user belonging to a large company and code suitable for supporting the work of a user belonging to a small-to-medium company are different from each other, the work support system 1 can generate code corresponding to the size of the organization to which the user belongs. When code suitable for supporting the work of a user who works in a food and beverage industry and code suitable for supporting the work of a user who works in an apparel industry are different from each other, the work support system 1 can generate code corresponding to the industry in which the user works.

### 6-6. Other Modification Examples

For example, two or more of Modification Examples 1 to 5 may be combined.

For example, the functions described as being implemented by the voice conversion server 10 may be implemented by the code generation server 20, the work support server 30, or the user terminal 40. The functions described as being implemented by the code generation server 20 may be implemented by the voice conversion server 10, the work support server 30, or the user terminal 40. The functions described as being implemented by the work support server 30 may be implemented by the voice conversion server 10, the code generation server 20, or the user terminal 40. The functions described as being implemented by the user terminal 40 may be implemented by the voice conversion server 10, the code generation server 20, or the work support server 30. The respective functions may be distributed to a plurality of computers, or may be implemented by a single computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A work support system, which is configured to support work of a user with no-code or low-code, the work support system comprising at least one processor configured to:
acquire, based on input of the user, extension content information relating to extension content of a work support function in the work support system;
generate, based on the extension content information and an AI, code for extension of the work support function; and
provide the code to the user.

2. The work support system according to claim 1, wherein the at least one processor is configured to:
acquire function setting information relating to a setting of the work support function; and
generate the code further based on the function setting information.

3. The work support system according to claim 1, wherein the at least one processor is configured to:
acquire a template code relating to the work support function, the template code being provided in advance; and
generate the code further based on the template code.

4. The work support system according to claim 3, wherein the at least one processor is configured to acquire the template code by searching a template database, in which a plurality of the template codes are stored, based on the extension content information.

5. The work support system according to claim 1, wherein the at least one processor is configured to:
acquire specification information relating to specifications required of the code; and
generate the code further based on the specification information.

6. The work support system according to claim 1, wherein the at least one processor is configured to:
acquire a default prompt relating to generation of the code, the default prompt being provided in advance; and
generate the code further based on the default prompt.

7. The work support system according to claim 1, wherein the at least one processor is configured to:
acquire the extension content information each time the user performs new input; and
generate the code further based on a history of the extension content information.

8. The work support system according to claim 1, wherein the at least one processor is configured to:
acquire, based on input of the user, correction content information relating to correction content of the code;
generate a correction portion code, which is post-correction code of a correction portion corresponding to the correction content in the code, based on the correction content information and the AI; and
correct the code by replacing the correction portion in the code by the correction portion code.

9. The work support system according to claim 1, wherein the at least one processor is configured to:
acquire, when the AI has supplemented a portion missing in the extension content information to generate the code, supplement content information relating to supplement content provided by the AI; and
further provide the supplement content to the user based on the supplement content information.

10. The work support system according to claim 1, wherein the at least one processor is configured to provide the code to the user by executing processing for displaying, on a user terminal of the user, a screen indicating a deployment result of the code.

11. A work support method for supporting work of a user with no-code or low-code, the work support method comprising:
acquiring, based on input of the user, extension content information relating to extension content of a work support function in a work support system;
generating, based on the extension content information and an AI, code for extension of the work support function; and
providing the code to the user.

12. A non-transitory information storage medium having stored thereon a program for causing a computer configured to support work of a user with no-code or low-code to:
acquire, based on input of the user, extension content information relating to extension content of a work support function in a work support system;
generate, based on the extension content information and an AI, code for extension of the work support function; and
provide the code to the user.
